(19) United States
(12) Patent Application Publication
(10) Pub. No.: US 2026/0204508 A1
(43) Pub. Date: Jul. 16, 2026

(54) X-RAY IMAGING SYSTEM

(71) Applicant: Carl Zeiss SMT GmbH, Oberkochen (DE)

(72) Inventor: Thomas Anthony CASE, Walnut Creek, CA (US)

(21) Appl. No.: 19/015,842

(22) Filed: Jan. 10, 2025

(51) Int. Cl. H01J 35/18

(52) U.S. Cl. CPC H01J 35/18; H01J 2235/18

(57) ABSTRACT

An x-ray imaging system for imaging a sample comprises: an x-ray source for generating x-rays; and a shield stop with an aperture. The shield stop is configured for transmitting an x-ray beam of the generated x-rays through the aperture and along an x-ray propagation axis of the system toward a region of interest of the sample and for blocking remaining x-rays. A geometric shape of the aperture is adapted to a diverging nature of the transmitted x-ray beam.

### INCORPORATION BY REFERENCE

This application incorporates by reference the following commonly owned applications filed on even date herewith:
U.S. Ser. No. ______ (Attorney Docket: 36066-0080001), entitled “X-Ray Source for an X-Ray Imaging System and X-Ray Imaging System”;
U.S. Ser. No. ______ (Attorney Docket: 36066-0081001), entitled “X-Ray Imaging System and Method for Operating an X-Ray Imaging System”;
U.S. Ser. No. ______ (Attorney Docket: 36066-0082001), entitled “Sample Mount Assembly for An X-Ray Imaging System and X-Ray Imaging System”;
U.S. Ser. No. ______ (Attorney Docket: 36066-0083001), entitled “X-Ray Source for an X-Ray Imaging System, X-Ray Imaging System and Method for Operating an X-Ray Imaging System”; and
U.S. Ser. No. ______ (Attorney Docket: 36066-0084001), entitled “X-Ray Detector Assembly, X-Ray Imaging System and Method for Manufacturing an X-Ray Detector Assembly”.

### FIELD

The present disclosure relates to an x-ray imaging system for imaging a sample.

### BACKGROUND

X-rays are widely used in microscopy at least in part because of their short wavelengths and ability to penetrate objects. Three-dimensional (3D) x-ray imaging techniques are useful to image internal structures of objects. Typically, based on a dataset including x-ray transmission images of a sample that are collected over a large angular range, 3D images are reconstructed. An x-ray imaging system usually comprises a rotatable sample mount to support a sample, an x-ray source configured to illuminate a region of interest of the sample, and a position-sensitive x-ray detector configured to record x-rays transmitted through the region of interest of the sample.

The x-ray source usually emits non-directed diverging x-rays from which only a fraction is used for inspecting the region of interest of the sample. When the sample is exposed to a high x-ray radiation amount, damages of the sample are possible. US 2023/046 280 A1 proposes an x-ray imaging system with a shield stop arranged between an x-ray source and a sample to protect uninspected regions of the sample.

### SUMMARY

The present disclosure seeks to provide an improved x-ray imaging system.

According to an aspect, the disclosure provides an x-ray imaging system for imaging a sample. The x-ray imaging system comprises: an x-ray source for generating x-rays; and a shield stop with an aperture, the shield stop being configured for transmitting an x-ray beam of the generated x-rays through the aperture and along an x-ray propagation axis of the system towards a region of interest of the sample and for blocking remaining x-rays, wherein a geometric shape of the aperture is adapted to a diverging nature of the transmitted x-ray beam.

Having the shield stop with the geometric shape of its aperture adapted to the diverging nature of the transmitted x-ray beam means that x-rays emitted by the x-ray source and not used for inspection of the sample can be better blocked from the sample. The uninspected regions of the sample can be better protected from x-ray exposure. Damage of the sample caused by x-rays can be reduced and/or avoided.

The x-ray imaging system can be configured for imaging a region of interest of a sample. The sample is, for example, a flat extended object. The sample is, for example, a wafer. The wafer includes, for example, electronic and/or semiconductor components. Just as an example, the x-ray imaging system may be used to inspect the wafer to investigate the quality of packaging of electronic components of the wafer. For example, the quality of mechanical and electrical bonding (e.g., buried interconnections) of the electronic components may be controlled. However, the sample may also be another type of object than a wafer. The sample may, for example, be a circuit board or a battery.

The x-ray imaging system is, for example, a transmission x-ray imaging system, wherein the x-rays impacting on the region of interest of the sample are partly transmitting the region of interest and are partly absorbed by the region of interest. The position-dependent transmitted portion of the x-rays can be detected by a position-sensitive x-ray detector assembly as a two-dimensional image.

The x-ray imaging system is, for example, an imaging system for three-dimensional x-ray imaging. The x-ray imaging system is, for example, configured to obtain two-dimensional transmission images of the region of interest for different rotation angles of the sample. Based on the obtained two-dimensional transmission images, a three-dimensional image of the region of interest is, for example, reconstructed to reveal interior structures of the region of interest. The x-ray imaging system is, for example, an x-ray imaging system for obtaining three-dimensional images by x-ray laminography and/or x-ray tomography.

The x-ray source can generate diverging x-rays, i. e. a cone (conus) of x-rays. A portion (e.g., a sub cone) of the generated diverging x-rays can irradiate the region of interest of the sample. A center line of this portion (e.g., sub cone) of x-rays is referred herein as x-ray propagation axis of the system. For example, the x-ray propagation axis extends from the x-ray source (e.g., a source region of the x-ray source), through the region of interest of the sample, and to an x-ray detector assembly of the system. This means that the x-ray propagation axis indicates the direction of an x-ray beam which is a portion of the total generated diverging x-rays of the x-ray source.

The shield stop is, for example, arranged between the x-ray source and/or an x-ray target of the x-ray source and the sample. In other words, the shield stop is, for example, arranged between the x-ray source and/or the x-ray target of the x-ray source and an object plane of the system, the object plane being configured for arranging the sample.

The shield stop is, for example, arranged spaced apart from the x-ray source. Alternatively, the shield stop is, for example, arranged adjacent the x-ray source (e.g., back-to-back with the x-ray source) and/or integrated with/embedded into the x-ray source.

The shield stop comprises, for example, an x-ray blocking material. The shield stop can be configured for transmitting x-rays through its aperture and blocking x-rays in the remaining part of the shield stop. In other words, the shield stop can be configured for transmitting a first portion of the generated x-rays (“transmitted x-ray beam”) through the aperture and towards the sample and for blocking a second portion of the generated x-rays such that the second portion does not reach the sample.

The shield stop is, for example, arranged in a light path of the diverging x-rays emitted from the x-ray source. The shield stop can serve to select a usable portion (e.g., sub cone) of the x-ray cone generated by the x-ray source. The x-ray beam transmitted through the aperture of the shield stop can propagate in the direction of the region of interest of the sample and can (partly) transmit through the region of interest of the sample towards the detector assembly. The x-ray beam transmitted through the aperture of the shield stop propagates, for example, along the x-ray propagation axis of the system.

The aperture of the shield stop is, for example, a through opening. The shield stop has, for example, an entrance face facing the x-ray source and/or the x-ray target of the x-ray source. Further, the shield stop has, for example, an exit face facing the object plane of the system (e.g., the sample arranged in the object plane). The aperture of the shield stop is, for example, extending from the entrance face to the exit face of the shield stop.

The shield stop is, for example, an extended object with a main plane of extension. The main plane of extension of the shield stop is, for example, arranged parallel to the object plane of the system. Further, the entrance face and the exit face of the shield stop are, for example, arranged parallel to each other and/or parallel to the main plane of extension of the shield stop.

The geometric shape of the aperture is adapted to a diverging nature of the transmitted x-ray beam. For example, the transmitted x-ray has a diverging beam shape. The diverging beam shape can include an opening angle of the beam that is greater than zero (e.g., an opening angle from 3° to 45°, from 5° to 30°, from 10° to 20°).

The geometric shape of the aperture is, for example, a three-dimensional shape of the aperture.

The geometric shape of the aperture is, for example, - in addition to being adapted to the diverging nature of the transmitted beam - adapted to an orientation of the x-ray propagation axis.

The aperture of the shield stop is, for example, a closed aperture as seen in cross section, the cross section taken parallel to the main plane of extension of the shield stop and/or perpendicular to the x-ray propagation axis. An inner wall of the shield stop defining the aperture can have, for example, a ring shape. The cross section of the aperture (parallel to the main plane of extension of the shield stop and/or perpendicular to the x-ray propagation axis) can have, for example, a circular, ellipsoidal, oval, trapezoidal, rectangular, quadratic and/or polygonal shape.

Alternatively, the aperture of the shield stop may, for example, also be a non-closed aperture as seen in cross section parallel to the main plane of extension of the shield stop and/or perpendicular to the x-ray propagation axis. In this case, the shield stop shields the x-rays generated by the x-ray source only on one side of the x-ray propagation axis but not on the other side.

The aperture of the shield stop is, for example, unfilled. Unfilled means herein free of (e.g., solid) material and includes that the aperture is filled with air and/or another gas (including a low-pressure atmosphere and/or vacuum atmosphere). Alternatively, the aperture of the shield stop is, for example, filled with an x-ray transmissive material.

In this application, “x-ray transmissive” means, for example, that the respective element has an x-ray transmission such that more than 50% of the x-rays generated by an x-ray target of the x-ray source having energies greater than one-half of the selected maximum focused electron energy are transmitted through the respective element.

In this application, “x-ray blocking” means, for example, that the respective element has an x-ray blocking effect such that more than 70%, more than 80% and/or more than 90% of the x-rays generated by an x-ray target of the x-ray source having energies greater than one-half of the selected maximum focused electron energy are blocked by the respective element.

The x-ray imaging system comprises, for example, a rotatable sample mount for supporting and rotating the sample. The sample mount comprises, for example, a support surface for supporting the sample. The support surface defines, for example, an object plane of the system.

The main plane of extension of the shield stop is, for example, arranged parallel to the object plane.

The x-ray propagation axis of the x-ray imaging system is, for example, inclined relative to the object plane by an acute angle.

The x-ray source comprises, for example, a vacuum chamber. Further, the x-ray source comprises, for example, a pump for evacuating the vacuum chamber. The x-ray source further comprises, for example, an electron source accommodated in the vacuum chamber. The electron source can be configured for emitting an electron beam towards an x-ray target of the x-ray source. The electron source includes, for example, a cathode and an anode and the like for generating electrons and for accelerating the generated electrons. The x-ray source further comprises, for example, one or more electron optics units for directing, deflecting and/or shaping the electron beam emitted from the electron source. The electron optics include, for example, one or more magnetic lenses for focusing the electron beam and/or one or more deflection units for deflecting the electron beam.

The x-ray source further comprises, for example, at least one x-ray target. The x-ray target can be configured for emitting x-rays when bombarded with the focused electron beam. A material of the at least one x-ray target comprises, for example, one or more of a group including tungsten (W), copper (Cu), chromium (Cr), molybdenum (Mo), rhodium (Rh) and platinum (Pt). The x-rays generated by the at least one x-ray target can include characteristic lines determined by the target's composition and broad bremsstrahlung radiation.

The x-ray source includes, for example, a carrier element carrying the x-ray target (or carrying multiple of the x-ray targets which can be selected by directing the electron beam accordingly). The carrier element is, for example, x-ray transmissive. The carrier element forms, for example, a vacuum window of the vacuum chamber. Alternatively, an additional vacuum window may be provided. A material of the carrier element and/or the vacuum window includes, for example, atomic elements having atomic numbers less than 14. The material of the carrier element and/or the vacuum window includes, for example, one or more of a group including beryllium (Be), diamond, boron carbide (B₄C), silicon carbide (SiC), aluminum (Al), and beryllium oxide (BeO). The material of the carrier element and/or the vacuum window can be diamond.

The carrier element has, for example, a sufficiently high thermal conductivity to provide a thermal conduit to prevent thermal damage (e.g., melting) of the at least one x-ray target. Further, the carrier element can, for example, also provide an electrically conductive path to dissipate electric charge from the at least one x-ray target and/or the carrier element itself.

The x-ray source is, for example, a transmission target type x-ray source. The electron beam can strike the at least one x-ray target of the x-ray source at its backside, the at least one x-ray target can emit x-rays at its front side, and the emitted x-rays can be used to irradiate the sample.

The x-ray imaging system comprises, for example, an x-ray detector assembly. The x-ray detector assembly is, for example, configured for position-sensitive x-ray detection of x-rays transmitted through the region of interest of the sample.

The x-ray detector assembly includes, for example, a scintillator element for converting incoming x-rays into detectable light (for example light of longer wavelength, e.g., ultraviolet light, visible light or infrared light). The x-ray detector assembly further includes, for example, a detector unit with a two-dimensional detector array (e.g., CMOS sensor, CCD) for detecting the detectable light. In addition, the x-ray detector assembly includes, for example, a unit (e.g., optics unit) for transferring the detectable light (magnified or non-magnified) from the scintillator element to the detector unit.

According to some embodiments, a cross-section size of the aperture parallel to a main plane of extension of the shield stop increases in a direction of the x-ray propagation axis.

A cross section of the aperture can broaden from an entrance of the aperture (at the entrance face of the shield stop) to an exit of the aperture (at the exit face of the shield stop) to adapt the geometric shape of the aperture to the diverging nature of the transmitted x-ray beam.

The cross-section size is, for example, a size of a cross-section area of the aperture parallel to a main plane of extension of the shield stop.

A cross-section size of the aperture perpendicular to the x-ray propagation axis can increase in the direction of the x-ray propagation axis.

According to some embodiments, the aperture comprises, as seen in a cross section along the x-ray propagation axis, at least one inclined inner wall inclined with respect to the x-ray propagation axis of the transmitted x-ray beam by half of an opening angle of the transmitted x-ray beam.

The at least one inner wall of the aperture of the shield stop can be inclined by an inclination angle which corresponds to half of the opening angle of the diverging x-ray beam (i.e. the transmitted x-ray beam).

The inclination angle of the inclined inner wall relative to the x-ray propagation axis can have, for example, a value of from 3° and 45° (e.g., from 5° to 30°, from 10° to 20°).

According to some embodiments, the x-ray imaging system comprises an object plane for arranging the sample, wherein the x-ray propagation axis of the system is inclined relative to the object plane.

According to some embodiments, the x-ray imaging system comprises an x-ray detector assembly with a two-dimensional detector array for detecting the x-ray beam transmitted through the region of interest of the sample and traveled along the x-ray propagation axis. Further, the x-ray propagation axis can be inclined relative to a main plane of extension of the shield stop. Furthermore, an actual cross-section shape of the aperture of the shield stop parallel to its main plane of extension can have, as seen in perspective from the detector array, an apparent shape matching a geometric shape of the detector array.

The detector array can have a two-dimensional detection field and/or pixel array with the two-dimensional geometric shape. The geometric shape of the detector array is, for example, a quadratic, rectangular, circular, polygonal shape and/or another two-dimensional shape.

The (two-dimensional) cross-section shape of the aperture of the shield stop (parallel to its main plane of extension) can be configured such that it matches, in a perspective view from the detector array, the (two-dimensional) geometric shape of the detector array. In other words, the apparent (two-dimensional) geometric shape of the cross section of the aperture of the shield stop, as viewed from the detector array, can have the same shape as the geometric shape of the detector array. Thus, the geometric shape of the aperture of the shield stop can be adapted to the geometric shape of the detector array to improve the shielding effect of the shield stop.

The actual cross-section shape of the aperture of the shield stop parallel to its main plane of extension can include, for example, the actual cross-section shape of the aperture in the main plane of extension of the shield stop, in a plane of the exit face of the shield stop, in a plane of the entrance face of the shield stop and/or in any plane between the entrance and exit planes.

The x-ray propagation axis of the system is, for example, inclined relative to the main plane of extension of the shield stop. Further, the detector array is, for example, arranged perpendicular to the x-ray propagation axis.

The actual cross-section size (e.g., cross-section area) of the aperture of the shield stop parallel to its main plane of extension can have, as seen in perspective from the detector array, an apparent size (e.g., cross-section area) matching a size (e.g., area) of the detector array.

According to some embodiments, the geometric shape of the detector array is a quadratic and/or a rectangular shape. Further, the actual cross-section shape of the aperture of the shield stop parallel to its main plane of extension can have a trapezoidal cross-section shape with, as seen in perspective from the detector array, an apparent shape matching the quadratic and/or rectangular shape of the detector array.

According to some embodiments, the geometric shape of the detector array is a circular shape. In addition, the actual cross-section shape of the aperture of the shield stop parallel to its main plane of extension can have an ellipsoidal cross-section shape with, as seen in perspective from the detector array, an apparent shape matching the circular shape of the detector array.

According to some embodiments, the x-ray source comprises a vacuum chamber with an x-ray transmissive vacuum window, and at least one x-ray target arranged in the vacuum chamber for generating x-rays and transmitting the generated x-rays through the vacuum window. Moreover, the shield stop can be integrated in the vacuum window.

By integrating the shield stop in the vacuum window of the x-ray source, a distance between the x-ray source and the sample can be configured small despite the presence of the shield stop.

A small distance between the x-ray source and the region of interest of the sample can be beneficial because the x-ray flux incident on the region of interest of the sample is generally inversely proportional to the square of the distance of the region of interest from the x-ray source, for example the x-ray target of the x-ray source. With the proposed configuration, a high x-ray flux density at the region of interest of the sample can be achieved. Further, a high x-ray flux density at the region of interest of the sample can implie short exposures times and, therefore, a relatively high throughput rate of samples during imaging.

According to some embodiments, the shield stop is embedded in the vacuum window such that the shield stop is accommodated in at least one recess of the vacuum window.

For example, an x-ray blocking material of the shield stop is accommodated in the at least one recess of the vacuum window. The x-ray blocking material of the shield stop is, for example, accommodated in the at least one recess of the vacuum window without a gap between the x-ray blocking material of the shield stop and the x-ray transmissive material of the vacuum window.

Having the shield stop embedded in the vacuum window of the x-ray source, a distance between the x-ray source and the sample can be configured even smaller. Thus, an x-ray flux density at the region of interest of the sample can be increased further leading to even shorter exposure times and a higher throughput rate.

According to some embodiments, the aperture of the shield stop is filled with an x-ray transmissive material of the vacuum window.

According to some embodiments, the shield stop is arranged at an outside surface of the vacuum window.

The shield stop is, for example, attached (e.g., glued etc.) to the outside surface of the vacuum window.

According to some embodiments, the x-ray source comprises a plurality of x-ray targets, and the x-ray imaging system comprises a plurality of shield stops, each shield stop being arranged corresponding to one of the x-ray targets.

Having the plurality of x-ray targets, another x-ray target can be relatively easily selected and used in case that an already used x-ray target became unusable. For example, an electron source of the x-ray source is configured to direct an emitted electron beam to a respective one of the plurality of x-ray targets to select it as current x-ray target.

The plurality of x-ray targets are, for example, arranged (e.g., spaced apart from each other) in a one-dimensional or a two-dimensional array as viewed in a direction perpendicular to an outer surface of the vacuum window. The outer surface of the vacuum window can face the object plane of the system (e.g., the sample arranged in the object plane). The x-ray source comprises, for example, 50 or more x-ray targets (e.g., 100 or more x-ray targets, 1000 or more x-ray targets). The number of shield stops equals, for example, the number of x-ray targets.

According to some embodiments, a thickness of the shield stop is 1000 microns (μm) or less (e.g., 500 μm or less, 200 μm or less, 100 μm or less, 50 μm or less).

The shield stop can be thin enough to allow arranging the sample close to the x-ray source. In general, it is desirable for the thickness of the shield to be large enough to stop, for example, 90% of incoming x-rays. A minimum thickness is, for example, 50 μm or 100 μm.

The thickness of the shield stop is, for example, a dimension of the shield stop in a direction perpendicular to its main plane of extension.

According to some embodiments, a material of the shield stop includes tungsten, bismuth, lead, platinum, depleted uranium, gold and/or one or more chemical elements with an atomic number above 70.

In general, a chemical element with a high atomic number (e.g., above 70), such as tungsten (W), bismuth (Bi), lead (Pb), platinum (Pt) and depleted uranium (U), has a good x-ray blocking property.

According to some embodiments, the shield stop is configured for adapting a size of the aperture.

The size of the aperture can be adapted for transmitting x-ray beams with different opening angles.

The shield stop is, for example, configured for adapting a cross-section size (e.g., cross-section area) of the aperture in a plane parallel to the main plane of extension of the shield stop.

The shield stop includes, for example, several shield elements being configured movable such that by moving the individual shield elements, the aperture can be increased or decreased. The shield stop is, for example, configured similar as an iris stop.

In some embodiments, the x-ray imaging system comprises a sample mount for supporting the sample rotatably around a rotation axis, wherein the x-ray imaging system is configured for obtaining two-dimensional transmission images of the region of interest of the sample for different rotation angles of the sample with respect to the rotation axis, and for reconstructing a three-dimensional image of the region of interest based on the two-dimensional transmission images.

The x-ray imaging system comprises, for example, a control device for reconstructing the three-dimensional images.

The x-ray imaging system can be configured for obtaining two-dimensional transmission images of the region of interest of the sample for different rotation angles of the sample with respect to the rotation axis, wherein the rotation angles span a large angular range of, for example, 180° or more (e.g., 270° or more, 360°).

Further possible implementations or alternative solutions of the disclosure also encompass combinations—that are not explicitly mentioned herein—of features described above or below with regard to the embodiments. The person skilled in the art may also add individual or isolated aspects and features to the most basic form of the disclosure.

### BRIEF DESCRIPTION OF THE DRAWINGS

Further embodiments, features and aspects of the present disclosure will become apparent from the subsequent description and dependent claims, taken in conjunction with the accompanying drawings, in which:

FIG. 1 shows a schematic view of an x-ray imaging system for imaging a sample;

FIG. 2 shows a partial view of a shield stop together with a transmitted x-ray beam of the x-ray imaging system of FIG. 1;

FIG. 3 shows a schematic view of an x-ray imaging system for imaging a sample;

FIG. 4 shows a partial view of a shield stop of the x-ray imaging system of FIG. 3;

FIG. 5 shows a schematic view of an x-ray imaging system for imaging a sample;

FIG. 6 shows a partial view of a shield stop of the x-ray imaging system of FIG. 5;

FIG. 7 shows a schematic view of an x-ray imaging system for imaging a sample;

FIG. 8 shows a shield stop integrated into a vacuum window of an x-ray source of the x-ray imaging system of FIG. 7;

FIG. 9 shows a plurality of shield stops integrated into a vacuum window of an x-ray source of the x-ray imaging system of FIG. 7;

FIG. 10 shows a shield stop integrated into a vacuum window of an x-ray source of the x-ray imaging system of FIG. 7; and

FIG. 11 shows a shield stop integrated into a vacuum window of an x-ray source of the x-ray imaging system of FIG. 7.

### DETAILED DESCRIPTION

In the Figures, like reference numerals designate like or functionally equivalent elements, unless otherwise indicated.

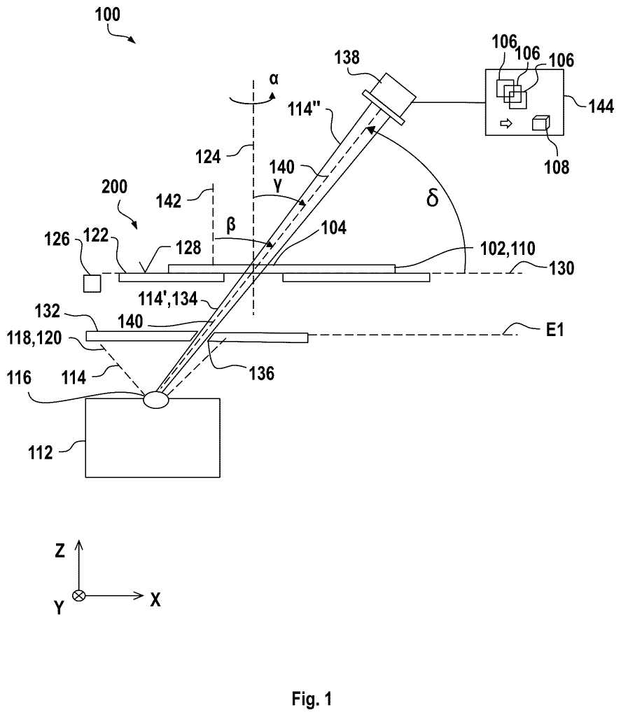

FIG. 1 shows a schematic view of an x-ray imaging system 100 according to an embodiment. The x-ray imaging system 100 is used for imaging a sample 102, for example a region of interest 104 of the sample 102. The x-ray imaging system 100 is configured to obtain two-dimensional transmission images 106 of the region of interest 104 for different rotation angles α of the sample 102. Based on the two-dimensional transmission images 106, a three-dimensional (3D) image 108 of the region of interest 104 is reconstructed to reveal interior structures of the region of interest 104. The x-ray imaging system 100 is, hence, an x-ray 3D imaging system obtaining 3D images 108 by x-ray laminography and/or x-ray tomography.

The sample 102 is, for example, a flat object extended in a main plane (e.g., the xy-plane in FIG. 1). The sample 102 is, for example, a wafer 110 comprising electronic and/or semiconductor components. Just as an example, the x-ray imaging system 100 may be used to inspect the wafer 110 to investigate the quality of packaging of electronic components of the wafer 110. For example, the quality of mechanical and electrical bonding (e.g., buried interconnections) of the electronic components may be controlled.

The x-ray imaging system 100 comprises an x-ray source 112 for emitting x-rays 114. The x-rays 114 are emitted from a source region 116 of the x-ray source 112. The x-ray source 112 emits a diverging beam 118 of x-rays 114. In other words, the x-ray source 112 emits a cone 120 of x-rays 114. The sample 102 is arranged within the x-ray emission cone 120.

The x-ray imaging system 100 further comprises a sample mount 122 for supporting the sample 102. The sample mount 122 is configured rotatable around a rotation axis 124. The rotation axis 124 passes, for example, through the region of interest 104 of the sample 102. For example, the rotation axis 124 can be arranged off-center with respect to a center of the sample 102. A rotation drive 126 for rotating the sample mount 122 and, hence, the sample 102, is shown schematically in FIG. 1. Furthermore, the sample mount 122 has a support surface 128 for supporting the sample 102, wherein the support surface 128 defines an object plane 130 of the x-ray imaging system 100.

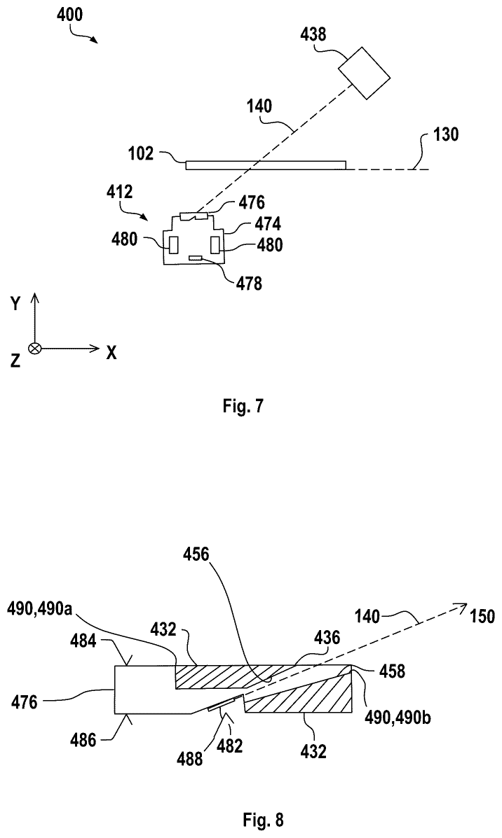

The x-ray imaging system 100 comprise in addition a shield stop 132 arranged between the x-ray source 112 and the object plane 130 (or between an x-ray target 482 of the x-ray source 412 and the object plane 130, see FIGS. 7, 8). The shield stop 132 is, for example, arranged in a light path of the x-rays 114 emitted from the x-ray source 112. The shield stop 132 serves to select a usable portion 134 of the x-ray cone 120. Moreover, the shield stop 132 protects uninspected regions of the sample 102 from x-ray exposure. The shield stop 132 has an aperture 136 through which the usable portion 134 (e.g., a sub cone 134) of the x-ray light 114 (114′) propagates in the direction of the region of interest 104 of the sample 102 and (at least partly) transmits the region of interest 104 of the sample 102.

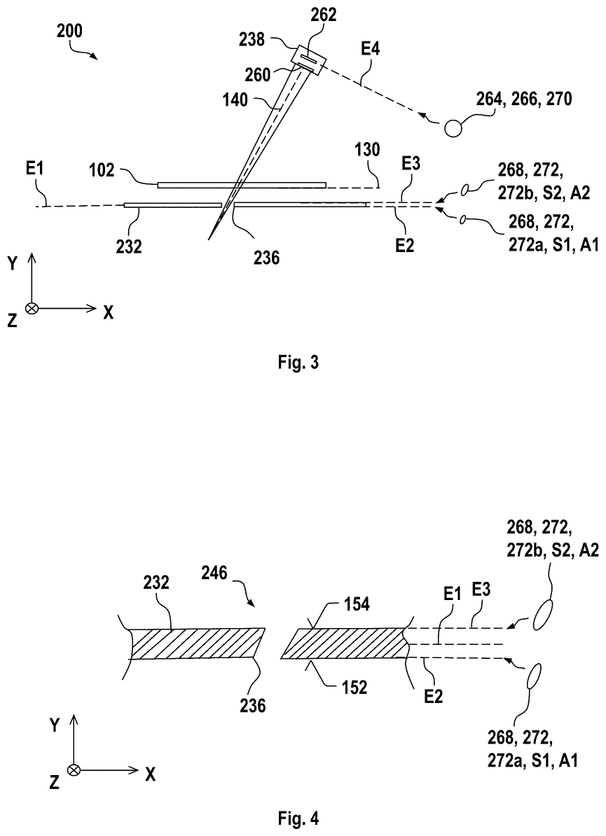

The x-ray imaging system 100 further comprises a position-sensitive x-ray detector assembly 138 for detecting x-rays 114″ transmitted through the region of interest 104 of the sample 102. The position-sensitive x-ray detector assembly 138 is, for example, configured to convert the incoming x-rays 114″ into light of longer wavelength, e.g., ultraviolet light, visible light or infrared light. The x-ray detector assembly 138 includes, for example, a scintillator material at an entrance window of the detector assembly 138 for converting the incoming x-rays 114″ into detectable light. The x-ray detector assembly 138 further includes, for example, and a detector array (e.g., a CMOS sensor or CCD) for detecting the detectable light (see detector array 262 in FIG. 3).

FIG. 1 displays an x-ray propagation axis 140 of the x-ray imaging system 100. For example, a central axis of the portion 134 (e.g., sub light cone 134) of the x-ray light 114 passing through the shield stop 132 defines the x-ray propagation axis 140. The x-ray propagation axis 140 extends from the x-ray source 112 (i.e., the source region 116 of the x-ray source 112), through the region of interest 104 of the sample 102, and to the position-sensitive x-ray detector assembly 138.

As can be seen in FIG. 1, the x-ray propagation axis 140 of the x-ray imaging system 100 is, for example, inclined with respect to a surface normal 142 of the sample mount 122 by a first angle β. In addition, the x-ray propagation axis 140 is, for example, inclined with respect to the rotation axis 124 by a second angle γ. In the example of FIG. 1, the surface normal 142 of the sample mount 122 and the rotation axis 124 are arranged parallel to each other and, hence, the first angle β and the second angle γ have the same size.

Furthermore, the x-ray propagation axis 140 of the x-ray imaging system 100 is, for example, inclined with respect to the object plane 130 by a third angle δ. Since the surface normal 142 of the sample mount 122 is perpendicular to the object plane 130 in FIG. 1, the sum of the first angle β and the third angle δ is 90° in FIG. 1 (β+δ=90°).

The x-ray exposures 106 obtained at different rotation angles α of the sample 102 are reconstructed to a 3D image 108 by a control system 144 of the imaging system 100.

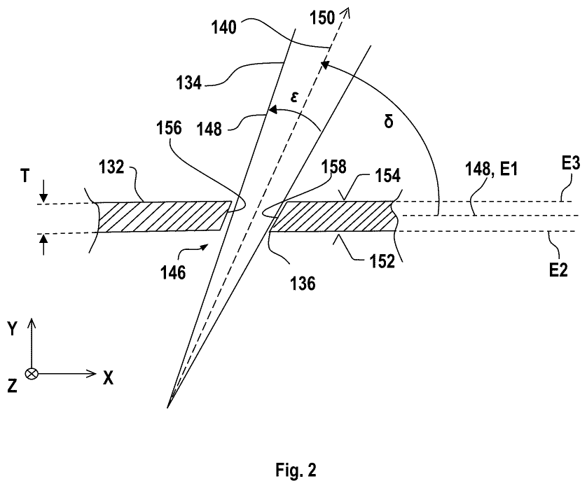

FIG. 2 shows a partial view of the shield stop 132 of FIG. 1. Visible in FIG. 2 is, for example, the aperture 136 of the shield stop 132. Furthermore, the x-ray beam 134 transmitted through the aperture 136 is shown in FIG. 1.

The shield stop 132 is configured for blocking that portion of the x-rays 114 emitted by the x-ray source 112 which is not used for inspection of the region of interest 104 of the sample 102. The shield stop 132 comprises, for example, an x-ray blocking material such as lead or the like.

The x-ray propagation axis 140 of the system 100 is inclined relative to the object plane 130 by the angle δ (FIG. 1). Further, a main plane E1 of extension of the shield stop 132 is, for example, arranged parallel to the object plane 130. Hence, the x-ray propagation axis 140 of the system 100 is also inclined relative to the main plane E1 of extension of the shield stop 132 by the angle δ (FIG. 2).

The shield stop 132 has an entrance face 152 facing the x-ray source 112 (FIG. 1) and/or an x-ray target of the x-ray source 112 (FIGS. 1, 7 and 8). Further, the shield stop 132 has an exit face 154 facing the object plane 130 of the system 100 (e.g., facing the sample 102 arranged in the object plane 130). A thickness T of the shield stop 132 between its entrance face 152 and its exit face 154 is, for example, 1 mm or smaller, 500 μm or smaller, 200 μm or smaller, 100 μm or smaller and/or 50 μm or smaller. Further, the aperture 136 of the shield stop 132 is, for example, extending from the entrance face 152 to the exit face 154 of the shield stop 132. The entrance face 152 is arranged in an entrance plane E2 of the shield stop 132. Further, the exit face 154 is arranged in an exit plane E3 of the shield stop 132. The entrance plane E2, the exit plane E3 and the main plane E1 of extension of the shield stop 132 are, for example, arranged parallel to each other.

As can be seen in FIG. 2, a geometric shape 146 of the aperture 132 is adapted to a diverging nature 148 of the transmitted x-ray beam 134. For example, the transmitted x-ray beam 134 is radiated along the x-ray propagation axis 140 and in the direction 150 of the x-ray propagation axis 140. Further, an opening angle ε of the x-ray beam 134 is larger than zero (e.g., 10° or larger, 20° or larger and/or 30° or larger) such that the x-ray beam 134 diverges during propagation.

The geometric shape 146 of the aperture 136 of the shield stop 132 is, for example, adapted to the diverging nature 148 of the transmitted x-ray beam 134 such that the cross section of the aperture 136 broadens in the direction 150 of the x-ray propagation axis 140. For example, a cross-section size S1 (e.g., cross-section area A1) of the aperture 136 in the entrance plane E2 is smaller than a cross-section size S2 (e.g., cross-section area A2) of the aperture 136 in the exit plane E3 (FIG. 3). Hence, the cross-section size S1, S2 (e.g., cross-section area A1, A2) of the aperture 136 parallel to the main plane E1 of extension of the shield stop 132 increases in the direction 150 of the x-ray propagation axis 140.

Furthermore, the geometric shape 146 of the aperture 136 of the shield stop 132 is, for example, adapted to the diverging nature 148 of the transmitted x-ray beam 134 by at least one inclined wall 156, 158. For example, FIG. 2 shows a cross-section view taken along the x-ray propagation axis 140. Further, the aperture 136 comprises in the view of FIG. 2 at least one inclined inner wall 156, 158 which is inclined with respect to the x-ray propagation axis 140. In the example of FIG. 2, two inclined walls 156, 158 of the aperture 136 are visible in the cross-section view. A first inclined wall 156 of the aperture 136 is inclined relative to the x-ray propagation axis by an angle of +ε/2, wherein ε is the opening angle of the transmitted x-ray beam 134. Further, a second inclined wall 158 of the aperture 136 is inclined relative to the x-ray propagation axis by an angle of −ε/2.

Optional, the shield stop 132 may be configured for adapting a size S1, S2 of the aperture 136. For example, if the shield stop 132 comprises two or more shielding elements (not shown), the two or more shielding elements may be configured movable relative to each other such that the aperture 136 can be increased or decreased. Hence, a shield stop 132 with a variable size may be provided. The shield stop 132 may, for example, be configured similar as an iris stop.

FIGS. 3 and 4 show an x-ray imaging system 200 according to a further embodiment. The x-ray imaging system 200 of FIGS. 3 and 4 is configured similar as the x-ray imaging system 100 of FIGS. 1 and 2. In the following, mainly only differences to the embodiment of FIGS. 1 and 2 are described. The x-ray imaging system 200 (FIGS. 3, 4) comprises, similar as the x-ray imaging system 100 (FIGS. 1, 2), an x-ray source and a sample mount (not shown in FIGS. 3, 4) and a shield stop 232. Further, the x-ray imaging system 200 comprises, similar as the x-ray imaging system 100, an x-ray detector assembly 238 with a scintillator element 260 and a two-dimensional detector array 262 (e.g., a CMOS sensor or CCD). Although not shown in the figures, between the scintillator element 260 and the two-dimensional detector array 262, a transmitting unit (e.g., optics unit) is arranged for transmitting the detectable light generated by the scintillator element 260 (magnified or non-magnified) to the detector array 262.

Further, similar as for the x-ray imaging system 100, the x-ray propagation axis 140 of the x-ray imaging system 200 is inclined relative to the object plane 130 and to the main plane E1 of extension of the shield stop 232. Further, the two-dimensional detector array 262 is arranged perpendicular to the x-ray propagation axis 140.

In the embodiment of FIGS. 3, 4, the two-dimensional detector array 262 has a geometric shape 264 which is exemplarily a circular shape 266. In FIG. 3, a detector plane E4 of the detector array 262 is illustrated. In other words, the two-dimensional detector array 262 is arranged in the detector plane E4. Further, the geometric shape 264 of the detector array 262 is, as an example, circular in the detector plane E4.

Moreover, the cross-section shape 268 of the aperture 236 of the shield stop 232 (parallel to its main plane of extension E1) is configured such that it matches, in a perspective view from the detector array 262, the geometric shape 264 of the detector array 262. In other words, an apparent geometric shape 270 of the cross-section 268 of the aperture 236 of the shield stop 232, as viewed from the detector assembly 238, has the same shape as the geometric shape 264, 266 of the detector array 262. Thus, the geometric shape 268 of the aperture 236 of the shield stop 232 is adapted to the geometric shape 264, 266 of the detector array 262 to improve a shielding effect of the shield stop 232.

In the embodiment of FIGS. 3, 4 (the actual cross-section shape 268 of the aperture 236 of the shield stop 232 parallel to its main plane E1 of extension is an ellipsoidal shape 272. In FIGS. 3, 4, actual cross-section shapes 272a, 272b of the aperture 236 of the shield stop 232 in both the entrance plane E2 and the exit plane E3 of the shield stop 232 are illustrated. In both planes E2, E3, the actual shape 272a, 272b of the aperture's cross section is an ellipsoidal shape. Further, a cross-section size S1 (e.g., a cross-section area A1) of the aperture 236 in the entrance plane E2 is smaller than a cross-section size S2 (e.g., a cross-section area A2) of the aperture 236 in the exit plane E3.

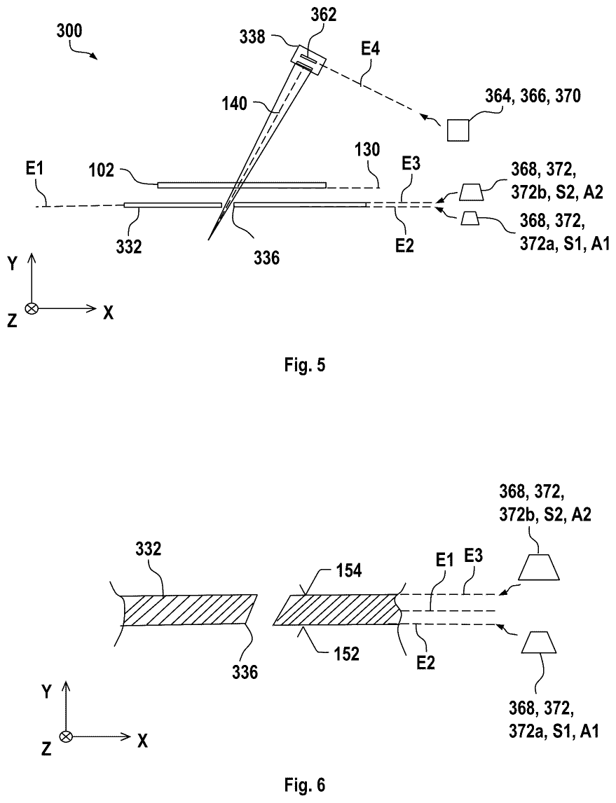

FIGS. 5, 6 show another example of a shield stop 332 having an aperture 336 whose cross-section shape 368 (parallel to its main plane of extension E1) is configured such that it matches, in a perspective view, the geometric shape 364 of the detector array 362. In the example of FIGS. 5, 6 the geometric shape 364 of the detector array 362 of the detector assembly 338 is a quadratic shape 366. Further, the actual cross-section shape 368 of the aperture 336 of the shield stop 332 parallel to its main plane E1 of extension (e.g., in the plane E1, E2 and/or E3) has a trapezoidal cross-section shape 372. As illustrated in FIG. 5, an apparent shape 370 of the actual cross-section shape 368 of the aperture 336 is a quadratic shape when viewed in perspective from the detector array 362. Hence, the apparent shape 370 of the actual cross-section shape 368 of the aperture 336 (which is quadratic) matches the quadratic shape 366 of the detector array 362.

FIG. 7 shows an x-ray imaging system 400 according to a further embodiment. In the following mainly only differences to the x-ray imaging system 100 in FIG. 1 are described.

The x-ray imaging system 400 (FIG. 7) comprises, similar as the x-ray imaging system 100 (FIGS. 1, 2), an x-ray source 412, a sample mount (not shown in FIG. 7) defining an object plane 130 and an x-ray detector assembly 438. Further, similar as for the x-ray imaging system 100, the x-ray propagation axis 140 of the x-ray imaging system 400 is inclined relative to the object plane 130.

Furthermore, the x-ray imaging system 400 (FIGS. 7, 8) comprises, similar as the x-ray imaging system 100 (FIGS. 1, 2), a shield stop 432 for shielding uninspected regions of the sample 102 from x-rays 114 (FIG. 1). However, in contrast to the x-ray imaging systems 100, 200, 300 (FIGS. 1 to 6), the shield stop 432 of the x-ray imaging system 400 (FIGS. 7, 8) is integrated in the x-ray source 412.

As shown in FIG. 7, the x-ray source 412 comprises a vacuum chamber 474 with an x-ray transmissive vacuum window 476. Further, the x-ray source 412 comprises inside the vacuum chamber 474, similar as the x-ray source 112 in FIGS. 1 to 6, an electron source 478 for emitting an electron beam, electron optics 480 for directing and shaping the electron beam and at least one x-ray target 482 for generating x-rays when irradiated with the electron beam. The generated x-rays are transmitted through the vacuum window 476. It is noted that although not shown, also the x-ray source 112 of the x-ray imaging systems 100, 200, 300 (FIGS. 1 to 6) may comprise a similar vacuum chamber, vacuum window, electron source, electron optics and x-ray target.

FIG. 8 shows a detailed view of the vacuum window 476 of the x-ray source of FIG. 7. The vacuum window 476 comprises an outside surface 484 facing an outside of the vacuum chamber 474 and an inside surface 486 facing an inside of the vacuum chamber 474. As can be seen in FIG. 8, the vacuum window 476 functions as a carrier element for carrying the at least one x-ray target 482. In other examples, also a separate carrier element for carrying the at least one x-ray target 482 may be provided in addition to the vacuum window 476.

In the example of FIG. 8, the vacuum window 476 (or alternatively a separate carrier element) has an inclined surface 488 for carrying the x-ray target 482 such that a longitudinal direction of the elongated x-ray target 482 coincides with the x-ray propagation axis 140. This configuration is beneficial for achieving a small source spot size of the x-ray source 412 and, hence, a high spatial resolution. Further, a large volume of the x-ray target 482 can be used for generating x-rays such that a high flux density at the region of interest 104 of the sample 102 is achieved. However, the at least one x-ray target 482 of the x-ray source 412 of any herein described x-ray imaging systems 100 to 400 may also have another configuration and/or orientation than that shown in FIG. 8.

In contrast to the embodiments of FIGS. 1 to 6, the shield stop 432 in FIGS. 7 to 11 is integrated in the vacuum window 476 of the x-ray source 412. In the example of FIG. 8, the vacuum window 476 comprises at least one recess 490, wherein an x-ray transmissive material of the vacuum window 476 is recessed. Further, the shield stop 432 is accommodated in the at least one recess 490 of the vacuum window 476 such that the at least one recess 490 is filled with x-ray blocking material of the shield stop 432. Thus, the shield stop 432 is embedded in the vacuum window 476.

In the example of FIG. 8, two recesses 490a, 490b are provided and filled with x-ray blocking material of the shield stop 432. Hence, an aperture 436 of the shield stop 432 is a closed aperture as seen in a cross section perpendicular to the x-ray propagation axis 140, similar as in FIGS. 1 to 6.

However, the second recess 490b is optional and it is possible to provide the x-ray blocking material of the shield stop 432 only in the first recess 490a. In this case, the aperture 432 would be a non-closed aperture as seen in a cross section perpendicular to the x-ray propagation axis 140.

A geometric shape 446 of the shield stop 432 is, similar as for the shield stop 132, 232, 332 in FIGS. 1 to 6, adapted to the diverging nature 148 of the transmitted x-ray beam 134 (FIG. 1). The configurations described with respect to the geometric shape 146 of the shield stop 132, 232, 332 in FIGS. 1 to 6 apply, mutatis mutandis, to the shield stop 432 to 732 in FIGS. 7 to 11. For example, also a cross-section size of the aperture 436 of the shield stope 432 increases in a direction 150 of the x-ray propagation axis 140. Further, the aperture 436 includes at least one inclined inner wall 456, 458 inclined with respect to the x-ray propagation axis 140 by half of an opening angle ε (i.e. ε/2) of the transmitted x-ray beam 134 (FIG. 1).

In the embodiment of FIGS. 7, 8, the aperture 436 of the shield stop 432 is filled with an x-ray transmissive material of the vacuum window 476.

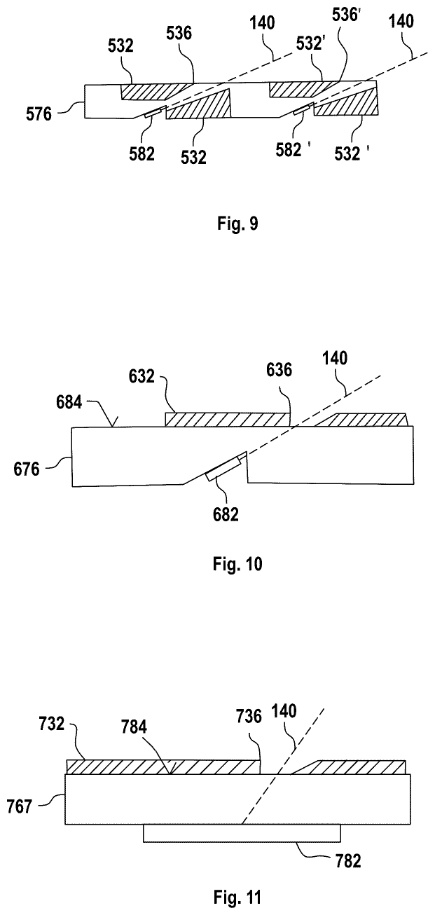

As shown in FIG. 9, the x-ray source 112, 412 of any herein described x-ray imaging system 100 to 400 (FIGS. 1 to 11) may also comprise a plurality of x-ray targets 582, 582′ and a plurality of shield stops 532, 532′with apertures 536,536′. FIG. 9 shows exemplarily two x-ray targets 582, 582′ and two shield stops 532, 532′. However, there may be provided many more than two x-ray targets 582, 582′ and two shield stops 532, 532′. As shown in FIG. 9, each shield stop 532, 532′ is arranged corresponding to one of the x-ray targets 582, 582′. Further, the shield stops 532, 532′ are integrated in a vacuum window 576 of the x-ray source 412.

FIG. 10 shows a further example of a shield stop 632 integrated in a vacuum window 676 of an x-ray source 412 (FIG. 7). The shield stop 632 has an aperture 636 adapted to the diverging nature of the transmitted x-ray beam 134 (FIG. 1). As illustrated in FIG. 10, the at least one shield stop 632 may also be arranged at an outside surface 684 of the vacuum window 676. The shield stop 632 is, for example, attached to the outside surface 684 of the vacuum window 676. The reference sign 682 denotes an x-ray target of the x-ray source 412.

FIG. 11 shows a further example of a shield stop 732 integrated in a vacuum window 767 of an x-ray source 412 (FIG. 7). The shield stop 732 has an aperture 736. Similar as in FIG. 10, the shield stop 732 is arranged at an outside surface 784 of the vacuum window 767. In FIG. 11, the x-ray target 782 has—in comparison to FIGS. 8 to 10—a different orientation relative to the vacuum window 767, for example to the outside surface 784 of the vacuum window.

Although the present disclosure has been described in accordance with preferred embodiments, it is obvious for the person skilled in the art that modifications are possible in all embodiments.

### REFERENCE NUMERALS

100 System
102 Sample
104 Region of interest
106 2D-Image
108 3D-Image
110 Wafer
112 Source
114 X-ray
114′,114″ X-ray
116 Source region
118 Beam
120 Cone
122 Mount
124 Axis
126 Rotation drive
128 Surface
130 Plane
132 Shield stop
134 Portion
136 Aperture
138 Detector assembly
140 Axis
142 Surface normal
144 Control system
146 Shape
148 Diverging nature
150 Direction
152 Entrance face
154 Exit face
156 Wall
158 Wall
200 Imaging system
232 Shield stop
236 Aperture
238 Detector assembly
260 Scintillator element
262 Detector array
264 Shape
266 Shape
268 Shape
270 Shape
272 Shape
272a,272b Shape
300 X-ray imaging system
332 Shield stop
336 Aperture
338 Detector assembly
362 Detector array
364 Shape
366 Quadratic shape
368 Cross-section shape
370 Apparent shape
372 Cross-section shape
372a,372b Cross-section shape
400 Imaging system
412 X-ray source
432 Shield stop
436 Aperture
438 Detector assembly
456 Wall
458 Wall
474 Vacuum chamber
476 Vacuum window
478 Electron source
480 Electron optics
482 X-ray target
484 Surface
486 Surface
488 Surface
490 Recess
490a,490b Recess
532,532′ Shield stop
536,536′ Aperture
576 Vacuum window
582,582′ X-ray target
632 Shield stop
636 Aperture
676 Vacuum window
682 X-ray target
684 Outside surface
732 Shield stop
736 Aperture
767 Vacuum window
782 X-ray target
784 Surface
α Angle
β Angle
γ Angle
δ Angle
ε Angle
A1, A2 Area
E1-E4 Plane
S1, S2 Cross-section size
T Thickness
X, Y, Z Direction

What is claimed is:

1. An x-ray imaging system, comprising:
an x-ray source configured to generate x-rays; and
a shield stop with an aperture,
wherein:
the shield stop is configured to transmit an x-ray beam of the generated x-rays through the aperture and along an x-ray propagation axis of the x-ray imaging system toward a region of interest of a sample and to block remaining x-rays; and
a geometric shape of the aperture is adapted to a diverging nature of the transmitted x-ray beam.

2. The x-ray imaging system of claim 1, wherein a cross-section size of the aperture parallel to a main plane of extension of the shield stop increases in a direction of the x-ray propagation axis.

3. The x-ray imaging system of claim 1, wherein the aperture comprises, as seen in a cross section along the x-ray propagation axis, an inner wall inclined with respect to the x-ray propagation axis by half of an opening angle of the transmitted x-ray beam.

4. The x-ray imaging system of claim 1, wherein the x-ray imaging system has an object plane configured to have the sample disposed therein, and the x-ray propagation axis is inclined relative to the object plane.

5. The x-ray imaging system of claim 1, further comprising an x-ray detector assembly which comprises a two-dimensional detector array configured to detect the x-ray beam transmitted through the region of interest of the sample travelling along the x-ray propagation axis, wherein:
the x-ray propagation axis is inclined relative to a main plane of extension of the shield stop; and
an actual cross-section shape of the aperture of the shield stop parallel to its main plane of extension has, as seen in perspective from the detector array, an apparent shape matching a geometric shape of the detector array.

6. The x-ray imaging system of claim 5, wherein:
the geometric shape of the detector array is a quadratic and/or rectangular;
the actual cross-section shape of the aperture of the shield stop parallel to its main plane of extension is trapezoidal.

7. The x-ray imaging system of claim 5, wherein:
the geometric shape of the detector array is circular; and
the actual cross-section shape of the aperture of the shield stop parallel to its main plane is ellipsoidal.

8. The x-ray imaging system of claim 1, wherein:
the x-ray source comprises a vacuum chamber which comprises an x-ray transmissive vacuum window;
the x-ray source comprises an x-ray target in the vacuum chamber configured to generate x-rays and to transmit the generated x-rays through the x-ray transmissive vacuum window; and
the shield stop is integrated in the vacuum window.

9. The x-ray imaging system of claim 8, wherein the shield stop is embedded in the vacuum window so that the shield stop is disposed in a recess of the vacuum window.

10. The x-ray imaging system of claim 8, wherein the aperture of the shield stop is filled with an x-ray transmissive material of the vacuum window.

11. The x-ray imaging system of claim 8, wherein the shield stop is at an outside surface of the vacuum window.

12. The x-ray imaging system of claim 8, wherein:
the x-ray source comprises a plurality of x-ray targets;
the x-ray imaging system comprises a plurality of shield stops; and
each shield stop is disposed according to a corresponding one of the x-ray targets.

13. The x-ray imaging system of claim 1, wherein the shield has a thickness of at most 1000 micrometers.

14. The x-ray imaging system of claim 1, wherein the shield stop comprises a material having an atomic number greater than 70.

15. The x-ray imaging system of claim 1, wherein the shield stop comprises a material selected from the group consisting tungsten, bismuth, lead, platinum, depleted uranium, and gold.

16. The x-ray imaging system of claim 1, wherein the shield stop is configured to adapt to a size of the aperture.

17. The x-ray imaging system of claim 1, wherein:
a cross-section size of the aperture parallel to a main plane of extension of the shield stop increases in a direction of the x-ray propagation axis; and
the aperture comprises, as seen in a cross section along the x-ray propagation axis, an inner wall inclined with respect to the x-ray propagation axis by half of an opening angle of the transmitted x-ray beam.

18. The x-ray imaging system of claim 17, wherein the x-ray imaging system has an object plane configured to have the sample disposed therein, and the x-ray propagation axis is inclined relative to the object plane.

19. The x-ray imaging system of claim 18, further comprising an x-ray detector assembly which comprises a two-dimensional detector array configured to detect the x-ray beam transmitted through the region of interest of the sample travelling along the x-ray propagation axis, wherein:
the x-ray propagation axis is inclined relative to a main plane of extension of the shield stop; and
an actual cross-section shape of the aperture of the shield stop parallel to its main plane of extension has, as seen in perspective from the detector array, an apparent shape matching a geometric shape of the detector array.

20. The x-ray imaging system of claim 19, wherein:
the x-ray source comprises a vacuum chamber which comprises an x-ray transmissive vacuum window;
the x-ray source comprises an x-ray target in the vacuum chamber configured to generate x-rays and to transmit the generated x-rays through the vacuum window; and
the shield stop is integrated in the vacuum window.
